(19) United States
(12) Patent Application Publication
(10) Pub. No.: US 2026/0143084 A1
(43) Pub. Date: May 21, 2026

(54) METHOD AND DEVICE FOR DETECTING WHETHER A VIDEO SIGNAL IS FROZEN

(71) Applicant: VSI Co. Ltd., Songpa-gu (KR)

(72) Inventor: Charles Jo, Yongin-si (KR)

(73) Assignee: VSI Co. Ltd., Songpa-gu (KR)

(21) Appl. No.: 19/062,150

(22) Filed: Feb. 25, 2025

(30) Foreign Application Priority Data
Nov. 19, 2024 (KR) 10-2024-0165695

(51) Int. Cl. H04N 17/00; H04N 7/035

(52) U.S. Cl. CPC H04N 7/0357

(57) ABSTRACT

A device according to the present invention includes: a first detection unit for detecting the start of each video frame and the start of each video line within the video frame in a received video stream, a second detector configured to detect a bit at a target position specified for an arbitrary video frame of the video stream based on the start of each video frame and the start of each video line detected by the first detector, and a decision unit configured to decide that the video stream is frozen if one or more target codes obtained from one or more bits individually detected by the second detector do not correspond to a specific code specified for the arbitrary video frame.

### RELATED PATENT APPLICATION

This application claims priority to commonly owned Korean Patent Application No. 10-2024-0165695, filed Nov. 19, 2024.

### TECHNICAL FIELD

The present invention relates to a technology that detects whether a video signal acquired through photographing or the like and provided through a channel is in a frozen state where one image is repeated.

### BACKGROUND

Research into autonomous travelling vehicles, autonomous mobile robots, and the like is actively being conducted, and semi-autonomous travelling is currently being applied to actual devices. A device that travels or moves autonomously or semi-autonomously in a state where a human is not involved has a function in which a learned AI determines the travelling or movement path or stops, accelerates, decelerates, etc. based on the video signal obtained by photographing using a camera.

In the case of vehicles, in order to enable the AI to recognize numerous complex situations on the road, numerous cameras facing the front, sides, rear, under each wheel, etc. are installed, and visual information about the situation around the vehicle is centrally transmitted to the AI. For this purpose, super-high speed internal communications are used. This is because when travelling at high speeds, the scene being photographed must be instantaneously dealt with the scene being photographed in a very short time.

However, even if the videos being photographed in multiple directions through super-high-speed internal communication are instantaneously transmitted to AI, normal decision regarding travelling cannot be made if there is a problem with the videos. A typical case where the video is problematic is the freezing of video due to contact defects or equipment or communication failures during the process from photographing to transmitting through the communication path to the receiving end. Frozen video means that images from an arbitrary time point are provided repeatedly, which is a completely different concept from the continuous provision of images of the same content due to the continuous photographing of the same scene.

If the video is frozen during autonomous travelling of a vehicle, it may cause serious problems leading to traffic accidents, and thus this frozen video must be essentially detected, and the detection must also be performed very quickly. When travelling at high speeds, for example at 100 km/h, the vehicle moves about 28 m per second. If movement occurs at this level in a state where the video is frozen, it may naturally lead to an accident, and thus it is necessary to detect whether a video is frozen within a period of time sufficiently faster than 1 second.

### DETAILED DESCRIPTION

### Technical Problem

According to aspects, there are provided a method and device capable of quickly detecting whether a video is frozen.

Aspects provide a method and device capable of detecting whether a video is frozen even if a part of the video is lost during transmission or processing.

Aspects provide a method and device for detecting frozen video that is tolerant to the loss of some video information while minimizing the amount of video information to be replaced in order to detect whether a video is frozen.

Aspects are not limited to the aspects explicitly stated above, and of course includes the purpose of achieving effects that can be derived from the following specific and exemplary description of the present invention.

### Technical Solution

According to an aspect of the present invention, there is provided a device for transmitting an input video stream to other devices through a communication channel, the device comprising: a detector that detects the start of each video frame and the start of each video line within the video frame in the input video stream, an inserter configured such that based on the start of each video frame and the start of each video line detected by the detector, in at least one of N (N is two or more) video frames that are temporally contiguous in a video stream, a specific mark consisting of 1 bit or more is inserted by replacing a part of the pixel data of the video stream, and the CRC data added to a video line with respect to the video line into which the bit of the replaced or inserted specific mark is replaced with CRC data that matches the video line including the replaced or inserted bit.

In an embodiment according to the present invention, the inserter is configured to insert the specific mark into each of the N video frames, and the specific mark inserted into each of the N video frames is composed of different codes. Further, the inserter repeatedly inserts the code of the specific mark multiple times for each video line of an arbitrary video frame, or inserts by every one bit into the code of the specific mark for each video line of an arbitrary video frame. In the latter case, the inserter may insert a bit of the code of the specific mark in such a manner that one bit is duplicated across multiple consecutive video lines in an arbitrary video frame.

In an embodiment according to the present invention, the different codes may be one bit string, or may be bit strings of more than that, and may be composed of pseudo noise codes having a specific bit length. In this case, the N is 4 or more, and bit values at the same position are not all the same between different codes from each other.

In another embodiment according to the present invention, the inserter skips one of the N video frames without inserting the specific mark. That is, the unwritten specific mark itself can function as a type of specific mark.

In an embodiment according to the present invention, the inserter inserts the specific mark into an arbitrary video frame by specifying a position different from the position where the specific mark was inserted in the video frame which is immediately preceding the arbitrary video frame. In this case, the different position may be specified in connection with the frame number written in a packet that packs the arbitrary video frame.

In an embodiment according to the present invention, the inserter replaces or inserts the bit of the specific mark in a video line of an arbitrary video frame, based on a bit length that is the least common multiple of the number of bits of a unit that completes information about one pixel and the number of bits in a byte.

In an embodiment according to the present invention, when the respective video lines are constituted in the form in which pixel data distinguished by brightness and color are continued, a video line portion in which a bit of the specific mark is replaced or inserted may be a portion of the pixel data of the color. Further, a video line portion in which the bit of the specific mark is replaced or inserted may be the least significant bit of the pixel data.

According to another aspect of the present invention, there is provided a device for detecting frozen video in a video stream received through a communication channel, the device comprising: a first detector that detects the start of each video frame and the start of each video line within the video frame in a received video stream, a second detector configured to detect a bit at a target position specified for an arbitrary video frame of the video stream based on the start of each video frame and the start of each video line detected by the first detector, and a decision unit configured to decide that the video stream is frozen if one or more target codes obtained from one or more bits individually detected by the second detector do not correspond to a specific code specified for the arbitrary video frame.

In an embodiment according to the present invention, the decision unit compares each of the one or more target codes with the specific code, and determines that the code does not correspond to the specific code if the matching number is less than a predetermined reference value.

In another embodiment according to the present invention, the decision unit calculates a correlation between the one or more target codes and the specific code of the continuous bit string, and decides that the code does not correspond to the specific code if a peak value equal to or greater than a certain limit value in the correlation is less than a predetermined reference value.

In yet another embodiment according to the present invention, the decision unit adds a specified number as a unit to a bit string in which the bits detected from the second detector are consecutively aligned and compare the result with a predetermined level, thereby obtaining one or more target codes through a method for deciding the specified number of bits as one bit of the target code and using them for comparison with a specific code.

In an embodiment according to the present invention, the decision unit determines the specific code by selecting from a set of a plurality of specific mark codes that are set in accordance with a predetermined order with a transmitter that transmits a video stream through a communication channel.

In another embodiment according to the present invention, the decision unit determines the specific code by selecting from the plurality of specific mark codes that are set in accordance with an order specified by information set in the passively operable switch elements.

In yet another embodiment according to the present invention, the decision unit determines the specific code as a target code obtained from detection by the second detector in a video frame received immediately preceding the arbitrary video frame.

In an embodiment according to the present invention, the second detector detects a bit by specifying, as a target position, a position different from the position at which the bit is detected in a video frame which is immediately preceding the arbitrary video frame. In this case, the target position of the arbitrary video frame may be specified based on a frame number written in a packet packing the arbitrary video frame.

In an embodiment according to the present invention, the decision unit continuously determines whether to freeze a subsequently received video stream for a preset period of time when the video stream is determined to be frozen. Further, the decision unit outputs a signal notifying the freezing of the video stream when the decision to freeze the video stream is sustained for each video frame for the period of time.

According to yet another aspect of the present invention, there is provided a method for transmitting an input video stream to other devices through a communication channel, the method comprising: a first step of detecting the start of an arbitrary video line within an arbitrary video frame in an input video stream, a second step of replacing or inserting a bit of pixel data written at a position that is specified from the detected starting point of the arbitrary video line with 1 bit of a specific mark to be inserted into the arbitrary video frame, and a third step of replacing CRC data added to a video line with respect an arbitrary video line in which at least one bit is replace or inserted, by CRC data that matches the video line containing the replaced or inserted bit.

According to still yet another aspect of the present invention, there is provided a method for detecting frozen video in a video stream received through a communication channel, the method comprising: a first step of detecting the start of an arbitrary video frame in a received video stream, a second step of detecting the start of each video line in the arbitrary video frame whose start has been detected, and detecting a bit at a target position that is specified for the arbitrary video frame based on the detected start of each video line, and a third step of obtaining one or more target codes from one or more bits individually detected in the second step, checking whether they correspond to a specific code specified for the arbitrary video frame, and determining that the video stream is frozen if they do not correspond to the specific code.

### Advantageous Effects

According to at least one embodiment of the present invention described above or described in detail below with the accompanying drawings, the method for detecting whether a video signal is frozen can detect immediately when receiving a single video frame that the video provided through photographing, etc. is in a frozen state where a previous image is repeated. As a result, it is possible to immediately take emergency measures for automatic operations such as autonomous travelling based on the received video, thereby improving the safety of automatic devices that depend on the video.

In addition, in the embodiments according to the present invention, even if an image of a video provided through photographing or the like is partially lost due to an error in communication or data processing, the decision of whether or not the video is frozen can be performed without being affected thereby, which ensures high tolerance to the detection of frozen video.

Furthermore, in some embodiments, the identifier of specific information inserted into the video during detection of frozen video is minimized while ensuring tolerance for partial video loss, thereby minimizing the impact on the visual expression of the video.

### BRIEF DESCRIPTION OF THE DRAWINGS

FIG. 1 is a block diagram showing the configuration of a watermark generator at a transmitting side and a frozen video detector at a receiving side, to which a method for detecting whether a video signal is frozen is applied according to an embodiment of the present invention;

FIG. 2 shows an example of a YUV422 8-bit type, which is one of the types defined in CSI-2 for a video stream, which is exemplarily presented for specifically explaining the embodiments of the present invention;

FIG. 3 shows an example of a method in which the watermark generator of FIG. 1 writes a watermark for a video stream of the format shown in FIG. 2 according to an embodiment of the present invention;

FIGS. 4a and 4b are detailed block diagrams of a writing scheduler and a watermark inserter of a watermark generator configured according to an embodiment of the present invention so as to be able to writes watermark bits as shown in FIG. 3;

FIG. 5 is an exemplary diagram showing a relationship between a control signal, which the write timing control unit of FIG. 4a adjusts the activation to determine the insertion point of the watermark bit, and a byte stream of the video stream according to an embodiment of the present invention;

FIG. 6 shows an example in which a plurality of watermarks are repeatedly inserted into each line of a video image frame according to an embodiment of the present invention;

FIG. 7 shows an example in which a plurality of multiple different watermark codes are inserted into the video frames while repeating them cyclically according to an embodiment of the present invention;

FIGS. 8a to 8c are detailed block diagrams of the reading scheduler, the mark bit detection unit, and the frozen decision unit of FIG. 1 configured according to an embodiment of the present invention;

FIG. 9 is a schematic diagram showing a process in which the frozen decision unit of FIG. 8c decides whether a received video stream is frozen according to an embodiment of the present invention;

FIG. 10 shows an example in which a watermark is inserted by every one bit into each line of a video frame according to another embodiment of the present invention;

FIG. 11 shows an example of inserting watermark bits for each video frame at different positions according to another embodiment of the present invention;

FIG. 12 is a schematic diagram showing a method for detecting a watermark inserted into a video frame through correlation according to an embodiment of the present invention;

FIG. 13 is an example showing a method of repeatedly inserting each bit of a watermark a certain number of times in succession across a plurality of video lines according to another embodiment of the present invention;

FIG. 14 is a detailed block diagram of a code detection unit for detecting a watermark inserted in the method of FIG. 13 according to an embodiment of the present invention;

FIG. 15 is a schematic diagram showing the process of detecting a watermark by the code detection unit of FIG. 14 in comparison with a normally received video frame and a video frame with some line defects;

FIGS. 16a and 16b show examples of each method of inserting a watermark while making a difference in the watermark between temporally contiguous video frames according to other embodiments of the present invention; and

FIG. 17 is a schematic diagram showing a method of deciding whether a video is frozen or not through comparison between two temporally contiguous frames at the receiving end according to an embodiment of the present invention, in relation to a method of inserting a watermark according to the method of FIG. 16a or FIG. 16b.

### DETAILED DESCRIPTION

Hereinafter, various embodiments of the present invention will be described in detail with reference to the accompanying drawings.

In the following description of embodiments according to the present invention and the accompanying drawings, the same numbers denotes the same components unless specified otherwise. Of course, for convenience of explanation and easy of understanding, the same components may also be denoted by different numbers, if necessary.

In the present invention, a specific mark is inserted into a video stream to detect whether a video is frozen, and this specific mark herein is referred to as a ‘watermark’. As will be specifically described in the description of the embodiments below, this watermark may be composed of a plurality of bits, or may be composed of 1 bit.

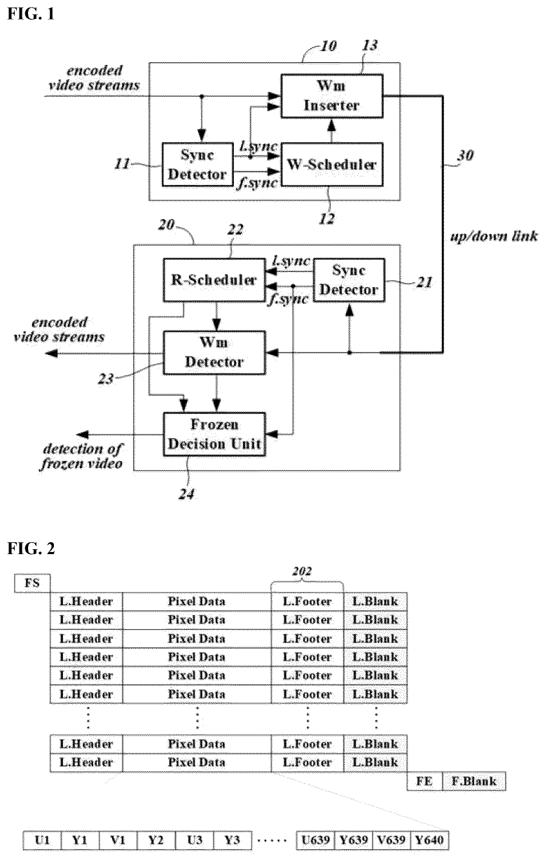

FIG. 1 is a block diagram showing the configuration of a watermark generator 10 and a frozen video detector 20, to which a method for detecting whether a video signal is frozen is applied according to an embodiment of the present invention. The illustrated watermark generator 10 and frozen video detector 20 are connected to each other by a link 30 for communicating with each other, and the communication interface that forms a communication channel for transmitting and receiving data to the link is not related to the present invention and therefore omitted from the corresponding drawings. A typical interface used for one-to-one communication can be applied to these communication interfaces.

Further, the watermark generator 10 is inserted and installed in a transmitter that provides video data acquired through a camera or the like using a communication channel, and the frozen video detector 20 is inserted and installed in a receiver that receives video data through the communication channel and transmits it to a post-stage device.

The watermark generator 10 is applied with a data stream of video (hereinafter referred to as a “video stream”) acquired and encoded by photographing or the like, the configuration of which largely includes a synchronous detector 11 that detects the synchronization at which a frame and each line start in the video stream, a watermark insertor 13 that inserts a watermark of a preset code into the video stream, and a writing scheduler 12 that provides a watermark code to be written and simultaneously controls the timing of inserting it into the watermark inserter 13.

The frozen video detector 20 is configured to include: a synchronous detector 21 that detects synchronization of frames and each line in a video stream received through a link 30, a mark bit detector 23 that extracts a bit (hereinafter referred to as ‘hidden bit’) corresponding to a watermark inserted in a video stream, a reading scheduler 22 that sets information on a watermark to be extracted and controls the timing of extracting the hidden bit of the mark bit detector 23, and a frozen decision unit 24 that decides whether the video data is about a frozen video based on a series of hidden bits detected by the mark bit detector 23.

FIG. 2 shows an example of a video stream packed a YUV422 8-bit (‘UYVY’) type, which is one of the types defined in CSI-2 (Camera Serial Interface-2) in order to specifically explain the embodiments of the present invention. The following embodiments are described based on the type illustrated in FIG. 2, but the technical idea and principle of the present invention are not necessarily limited to the type illustrated. The specific description with reference to FIG. 2 can be applied to any number of cases of video streams packed in different formats through simple substitution, replacement or the like due to the difference in the types of video streams. Therefore, unless the claims of the present invention explicitly limit the application to the embodiments, the scope of the present invention should not be construed as being excluded because of different packing formats of the video stream.

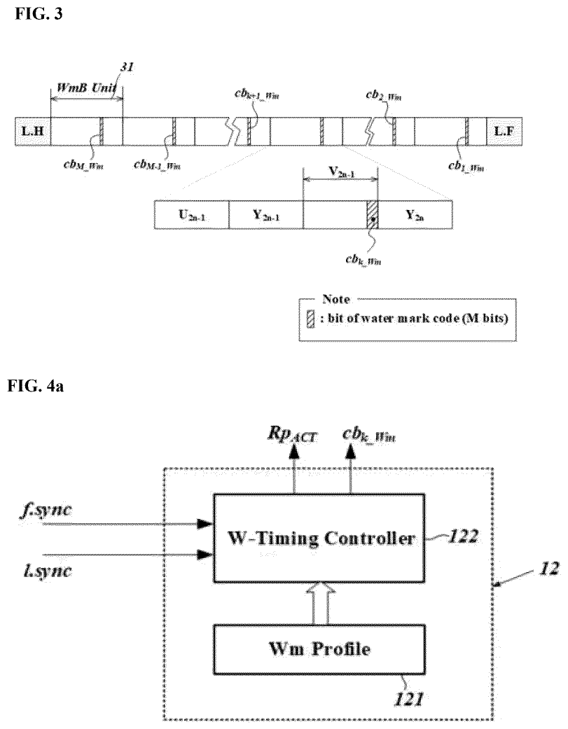

FIG. 3 shows an example of a method in which the watermark generator 10 writes a watermark for a video stream of the format shown in FIG. 2 according to an embodiment of the present invention.

The example of FIG. 3 is about an example of writing a watermark for one line of the video stream of FIG. 2, and the watermark generator 10 writes one hidden bit for each unit section 31, which is specified according to the packed data type of the video stream, by replacing the pixel data bits at the corresponding position. In an embodiment according to the present invention, this unit section is specified by a size that is the least common multiple of the number of bits and bytes of data that complete information about one pixel. For example, the YUV422 8-bit type of FIG. 2 must include U and V pixel data so that the brightness and color of two pixels are decided simultaneously, each pixel data is completed, and 32 bits are a multiple of bytes. Therefore, in the case of the YUV422 8-bit type, the unit section is 4 bytes.

If the packing format of the video stream to be applied is YUV422 10-bit type, then it should be 40 bits to become a multiple of 5 bytes while determining the brightness and color of 4 pixels, and therefore the unit section becomes 5 bytes. If the format is RGB666 type, then it should be 4 pixels of 18 bits to become a multiple of 9 bytes, and therefore the unit section becomes 9 bytes.

In this way, if hidden bits are written as units of the sections that are the least common multiples of pixel data and bytes, there is an advantage that the hardware configuration for inserting and detecting hidden bits for packed video streams can be further simplified.

In another embodiment of the present invention, instead of writing hidden bits for each fixed unit section as explained above, hidden bits may be written for each section corresponding to an arbitrary multiple of the unit section.

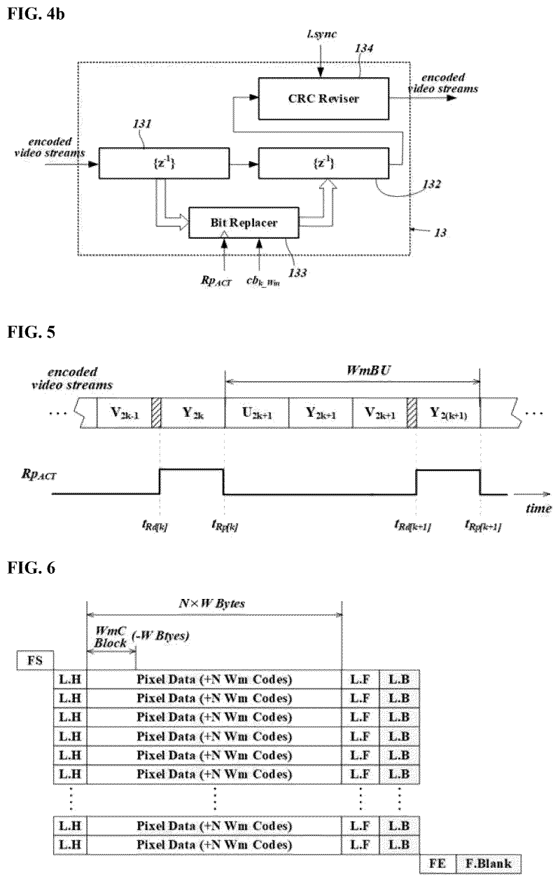

FIGS. 4a and 4b are detailed block diagrams of a writing scheduler 12 and a watermark inserter 13 of a watermark generator that are configured according to an embodiment of the present invention so as to be able to writes hidden bits as shown in FIG. 3, wherein the writing scheduler 12 is configured to include a watermark profile 121 and a write timing controller 122, and the watermark inserter 13 is configured to include a first delay register 131, a second delay register 132, a bit replacer 133, and a CRC (Cyclic Redundancy Check) reviser 134.

The watermark profile 121 sets information about one or more watermark codes to be used to detect whether a video is frozen, and information about the method and section for writing the hidden bit of the watermark for various video stream packing types. This watermark profile 121 may be set in the writing scheduler 12 by hardware or hard-coding, or alternatively, may be set by a manually operable switch element or the like.

The write timing controller 122 has a function of activating a signal (Rp_{ACT}) that controls hidden bit insertion, based on the video frame and line synchronization detection time point notified by the synchronous detector 11, and one or more watermark codes, their writing method, and write section information specified by the watermark profile 121, and also a function of outputting the hidden bit (cbk=) required at the corresponding time point.

The first and second delay registers 131 and 132 of the watermark inserter 13 are circuit-connected so that the bits of the video stream are sequentially applied in series, delayed by the number of bits of the corresponding register, and then completely output in series. The bit replacer 133 is circuit-connected so as to read data in parallel from the first delay register 131 and write data in parallel to the second delay register 132. The CRC reviser 134 is circuit-connected so as to generate CRC data for a bit string output while being shifted from the second delay register 132 and reinsert it into the output bit string.

In an embodiment in which the write timing controller 122 and the watermark inserter 13 are respectively configured as shown in FIGS. 4a and 4b, if the watermark profile 121 specifies the packing type of the currently applied video stream as YUV422 8-bit, the format of which is shown in FIG. 2, the writing method is to write a watermark code on each video line, and the unit section is specified as 4 bytes, the write timing controller 122 starts counting the bits of the video stream from the line synchronization detection notification point when the third byte (corresponding to the byte where the hidden bit is written) ends (t_{Rd[k]}), activates the write control signal (Rp_{ACT}), maintains it for 1 byte, then deactivates it (t_{Rd[k]}), and repeats this activation control for each unit section (WmBU), based on this information specified for the watermark profile 121, as shown in FIG. 5.

In FIG. 5 and the above description, the reason why the start point of activating the write control signal (Rp_{ACT}) is set to the point at which the third byte ends (the point at which the fourth byte starts), i.e., the reason why the hidden bit is written starting from the 3rd byte, is to allow the hidden bits to be transported through the color component that is relatively less sensitive to changes compared to brightness in the video stream. Therefore, the write control signal can also be activated at the time point when the first byte, which is another color component, ends (when the second byte starts) after the video line starts. Of course, in the example, the start point of the activation of the write control signal is defined due to the packing of the ‘UYVY’ format, and in the case of a different order of packing, e.g., the packing of the ‘YUYV’ format, the start point would be from the 3rd or 5th byte.

In the above description, the write control signal is maintained in an activated state for only one byte, but this may vary depending on the bit size of the first and second delay registers 131 and 132. For example, if these registers have a size of 16 bits, the activated write control signal may be released after lasting for two bytes. The reason for this operation is that the operation for inserting the hidden bit according to the present embodiment is performed as follows.

When the bit replacer 133 of the watermark inserter 13 detects the transition of the write control signal (Rp_{ACT}) to the activated state, it reads out all the bits filled in the first delay register 131 at once at that time point tRd[i], where i=k, k+1 . . . ). As described above, the write control signal (Rp_{ACT}) transitions to the activated state at the start point of the next byte of the byte into which the hidden bit is written (hereinafter referred to as the “target byte”), so the time point at which the write control signal (Rp_{ACT}) transitions to the activated state is in a state where the last bit of the target byte is input to the first delay register 131. Therefore, the byte read by the bit replacer 133 directly becomes the target byte.

As mentioned above, depending on the bit size of the first and second delay registers 131 and 132, it is possible to read out a bit string including a target byte.

The bit replacer 133 replaces the least significant bit (this bit corresponds to the least significant bit of the target byte) of the read bit string with the hidden bit (cb_{k_WM}) currently applied from the write timing controller 122. The bit string replaced with the hidden bit is loaded into the second delay register 132 in parallel at once at the time point when the active state of the write control signal (Rp_{ACT}) is released (t_{Rp[i]}, i=k, k+1, . . . ).

As explained above, the record control signal (Rp_{ACT}) is maintained in an active state by the number of bits of the first and second delay registers 131 and 132, so the time point when the active state is released is a state where the target byte or the bit string including the target byte in the first delay register 131 is accurately shifted to the second delay register 132 by the system clock applied to the registers. Therefore, if the target byte or bit string replaced with the hidden bit at that time point is loaded at once, a series of bits in which only the lowest bit of the target byte is replaced with the hidden bit without any change to the values of other bits are applied to the post-stage CRC reviser 134.

The reason for replacing the least significant bit in the target byte by a hidden bit is to minimize the effect of the replacement of the hidden bit on the color expressed by the target byte.

The CRC reviser 134 generates CRC data for the bits input from the time point when line synchronization is detected until a prescribed number of bits are input, so that when a specified CRC field position (this position may be the start point of the trailer 202 of each video line, or a specific point therein) is reached, it sequentially outputs the generated CRC bit string instead of the bit string of the currently input video stream. Thus, CRC data replacing the existing CRC data of the current video line is output to the output end of the watermark inserter 13. As a result, the CRC data changed due to the hidden bits intermittently inserted into the corresponding video line is inserted into the trailer 202 of that video line and transmitted to the receiving terminal.

The detailed block diagram of the writing scheduler 12 and the watermark inserter 13 shown in FIGS. 4a and 4b is only one detailed configuration for inserting hidden bits constituting a watermark one by one for each unit section of the video stream. The hidden bit insertion operation as described above can be implemented through circuit configurations different from those illustrated.

On the other hand, each time the write timing controller 122 activates the write control signal (Rp_{ACT}) as described above, it starts from the beginning of the watermark code currently being recorded, sequentially selects by one bit at a time, and applies it to the bit replacer 133. When the detection of line synchronization is notified from the synchronous detector 11, the same operation as that performed on the previous image line for the same watermark code is repeated.

If the watermark code cannot be completely inserted into the remaining bytes of the current line at the time repeatedly inserting the watermark code into each video line, the watermark code insertion for the current line is stopped, and the watermark code is repeatedly inserted again when the next line starts. For example, if a line of a video stream packed in RGB666 type consists of 640 pixels, a hidden bit is written for every 4 pixels that become 9 bytes, in which case a total of 160 bits are required for one watermark code. However, if the watermark code consists of 64 bits, t is not possible to completely write the 64-bit watermark code for the bytes of the line that remain after two writings. In this case, the write timing controller 122 stops writing any more hidden bits for the corresponding line when the watermark code is written twice.

In this way, the watermark policy information that specifies the number of times the watermark code is written for each video line in relation to information related to the packing format of the video stream in which the watermark is written and the number of pixels of the video line, etc., is set in the watermark profile 121, and the write timing controller 122 decides the number of times the write control signal (Rp_{ACT}) for each video line is activated, with reference to this watermark policy information.

As described above, since the position on the video line where the writing of the hidden bit should start varies depending on the packing type of the video stream, information about the writing start point for each type is also set in the watermark policy information, and the write timing controller 122 decides the time point at which to activate the write control signal (Rp_{ACT}) for each video line from this start point information.

In addition, the watermark policy information may include information about whether a single watermark code is to be used or multiple watermark codes are to be used, and, when multiple watermark codes are to be used, and may also include information about the code sequence, in terms of the order in which the watermark codes are to be repeatedly recorded, when multiple watermark codes are used.

All of the writing methods of the watermark code according to the various embodiments described below can be set and referenced in the watermark policy information. Further, the watermark profile 121 is configured to include a selection switch that can be manually set from the outside, and can be operated by this selection switch so that one of various writing methods defined by the set watermark policy information is applied.

According to the writing of the watermark code according to the embodiment described above, any frame of the video stream repeatedly writes the watermark code in each video line as shown in FIG. 6. The example of FIG. 6 is based on the assumption that one watermark code is scattered and inserted into W bytes (the entire bytes into which one watermark code is inserted are referred to as a ‘code block’), and that the video line consists of N×W bytes.

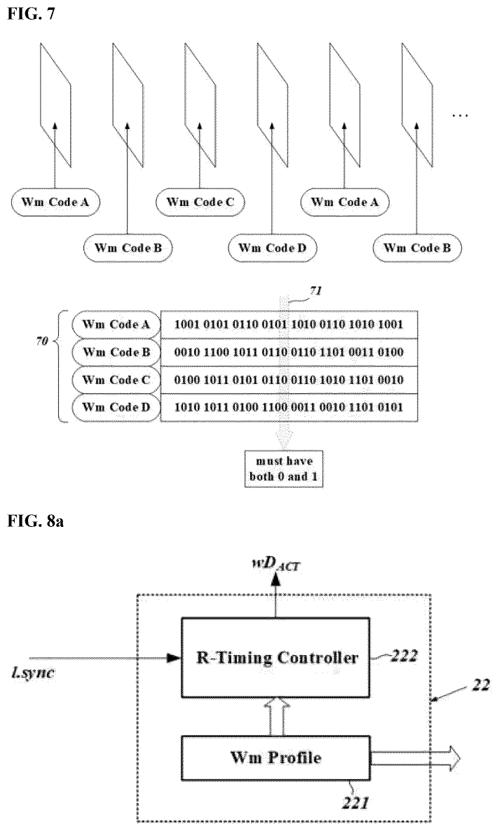

As mentioned above, when the watermark policy information specifies that multiple watermark codes are to be applied, the write timing controller 122 loads all watermark codes to be used from the writing scheduler 12 in the initial operation of the watermark generator 10, and each time frame synchronization detection is notified from the synchronous detector 11, the watermark code is changed to the next procedure according to the code sequence defined in the watermark policy information, and its hidden bits are inserted into the corresponding frame as in FIG. 6 in the same manner as described above. According to this writing method, a series of watermark codes are cyclically repeated and inserted into each video frame for transmission, as shown in FIG. 7.

As shown in FIG. 7, the watermark codes 70 that are inserted cyclically and repeatedly are composed of pseudo noise codes, and between hidden bits in the same position, at least one is codes having different values (71). This is to suppress the correlation between the watermark codes inserted at the same position of the preceding and following frames as much as possible, and at the same time, to prevent a specific bit of pixel data, i.e., the least significant bit in the embodiment of the present invention, from always having the same value, thereby eliminating the possibility that the visual expression by the hidden bit may be prominent.

Next, the operation of the frozen video detector 20 provided at the receiving end side of the video stream, which detects whether a video stream is frozen, is described for the video stream in which watermark codes are inserted and transmitted as shown in FIGS. 6 and 7.

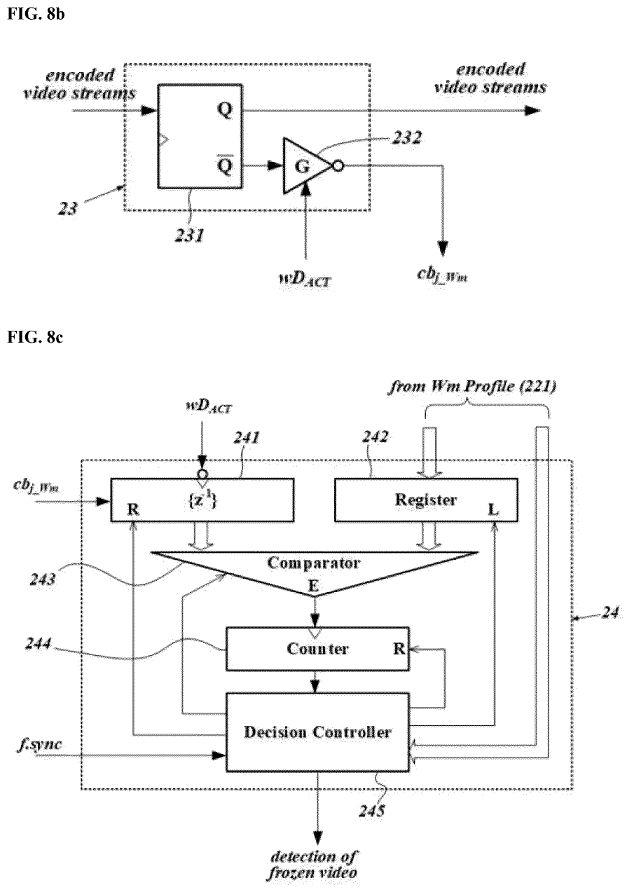

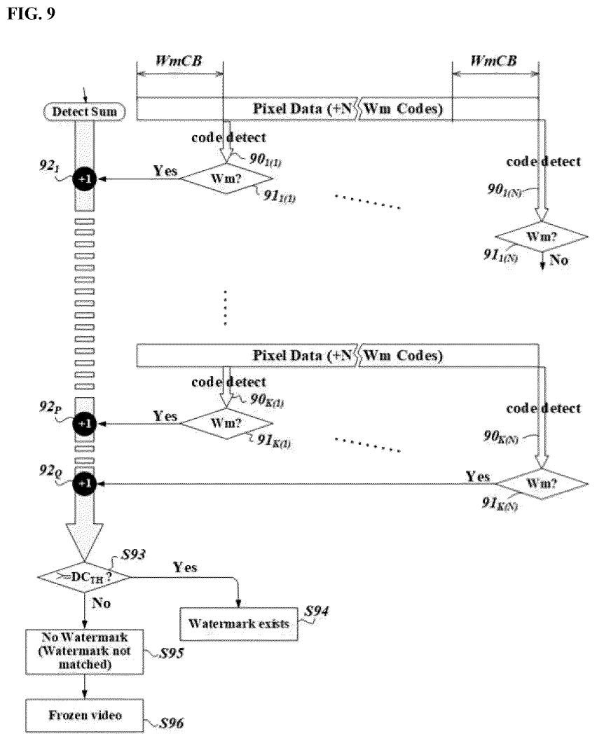

FIGS. 8a to 8c are detailed block diagrams of the reading scheduler 22, the mark bit detection unit 23, and the frozen decision unit 24 configured according to an embodiment of the present invention. The reading scheduler 22 is configured to include a watermark profile 221 and a detection timing controller 222, and the watermark profile 221 can be set to the same information as that provided in the watermark generator 10 and provided in the reading scheduler 22. Further, the detection timing controller 222 has a function of activating a signal (_{W}D_{ACT}) for controlling hidden bit detection based on the image frame and line synchronization detection time points provided by the synchronous detector 21 of the frozen video detector 20, and one or more watermark codes, their recording method, and recording section information specified by the watermark profile 221. This detection control signal (_{W}D_{ACT}) is activated for a time corresponding to one bit and then immediately released.

The mark bit detector 23 is configured to include a flip-flop 231 that delays the received video stream by one bit and outputs it, and a gate 232 that outputs the bit of the flip-flop 231 as a watermark corresponding bit (cb_{j_WM}) when the detection control signal (_{W}D_{ACT}) transitions to an activated state.

The frozen decision unit 24 shown in FIG. 8c includes a shift register 241 that loads the bit (cb_{j_WM}) applied from the gate 232 at the falling point of the detection control signal (_{W}D_{ACT}) and shifts it by one bit, and a register 242 in which one of the watermark codes set in the watermark profile 221 is loaded at a time, and these registers 241 and 242 have a bit size equal to the number of bits of the watermark code.

The frozen decision unit 24 is also configured to include a comparator 243 that compares the values recorded in the registers 241 and 242 with each other and outputs an active pulse when the values are equal, a counter 244 that increases a count value when an active pulse occurs in the output signal of the comparator 243, and a decision controller 245 that decides whether the immediately preceding frame was a frozen video based on the value of the counter 244 and the watermark policy information confirmed from the watermark profile 221 when detection of frame synchronization is notified from the synchronous detector 21.

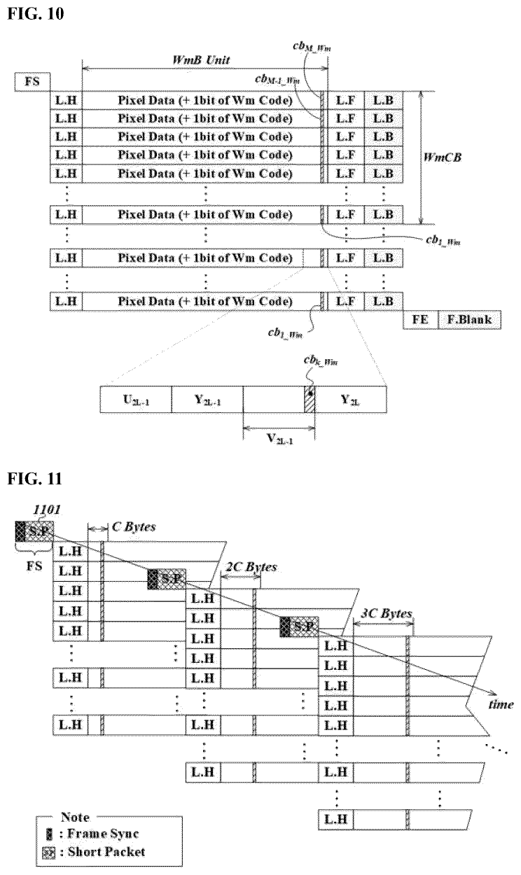

The operation of the frozen decision unit 24 having the detailed configuration shown in FIGS. 8a to 8c is described. FIG. 9 is a schematic diagram showing a process in which the frozen decision unit 24 decides whether a received video stream is frozen according to an embodiment of the present invention.

The detection timing controller 222 decides the activation point of the detection control signal (_{W}D_{ACT}) for each video line in the same manner as described above for the write timing controller 122, and repeatedly activates it for each unit section confirmed from the watermark policy information. At the time point when this detection control signal (_{W}D_{ACT}) transitions to the activation, the bit of the hidden recording position in the corresponding line is in a state of being latched in the flip-flop 231. Therefore, the latched bit is output from the gate 232 by the edge of the detection control signal (_{W}D_{ACT}) transitioning to activation.

The output value of this gate 232 is applied serially to the shift register 241, and at the edge where the active state of the detection control signal (_{W}D_{ACT}) is released, the existing bits are shifted by one bit at a time while being latched into the shift register 241.

By such a detection operation, a set of bits (hereinafter referred to as ‘target code’) individually detected at target positions, which are the positions where hidden bits are written, in each code block (WmCB) for each video line are filled into the shift register 241.

On the other hand, in response to the frame synchronization detection notification applied from the synchronous detector 21 after the frozen video detector 20 is started, the decision controller 245 loads the watermark code to be detected in the subsequent video frame from the watermark profile 221 into the register 242. Whether a watermark code should be loaded for the current sequence of video frames is decided by the code sequence of the watermark policy information contained in the watermark profile 221.

The decision controller 245 applies a load signal to the comparator 243 every time a bit corresponding to each code block confirmed by the system clock is input, thereby loading the values of the shift register 241 and the register 242, and comparing the current target code (90ᵢ₍ⱼ₎, i=1, . . . , K, j=1, . . . , N) with the watermark code of the register 242 that the current frame should be loaded with (91ᵢ₍ⱼ₎, i=1, . . . , K, j=1, . . . , N). At the same time, a reset signal is applied to the shift register 241 so that the next target code can be input again.

If the comparison results of the comparator 243 are equal to each other, an active pulse is output, and if they are not equal, no state change appears at the output stage. If an active pulse is output, the counter 244 increases the current count value by 1 (92ᵢ, i=1, . . . , P, . . . , Q). According to this operation, the number of detections for the watermark code that should be written in the current video frame is accumulated in the counter 244.

Finally, if a frame synchronization detection notification is finally received, the decision controller 245 reads the value of the counter 244 and compares it with the preset detection threshold (S93). This detection threshold may be included in and referenced by the watermark policy information. If the count value is equal to or greater than the detection threshold, it is decided that the watermark code is normally written in the immediately preceding video frame S94. Otherwise, it is decided that the watermark is not detected (S95).

When the video is frozen, the watermark code of the video frame is not repeated cyclically while changing according to the code sequence, but the same watermark code is repeated. Therefore, even if the watermark code is detected in the video frame, there may be cases where it does not match the watermark code that is sequentially loaded into the register 242 according to the code sequence specified in the watermark policy information after the frame starts in the video stream, in which case it is decided that no watermark has been detected for the corresponding frame.

Therefore, if it is confirmed that the watermark is not detected, the decision controller 245 decides that the current video frame is frozen (S96) and outputs a warning signal. This warning signal is transmitted to a device in charge of emergency processing due to video freezing, for example, another electronic control unit (ECU) installed in the vehicle.

In an embodiment of the present invention, when a watermark is not detected, a warning signal is not output immediately thereafter, but the frozen video decision can be continued for a certain delay time. This delay time can be specified in the watermark policy information mentioned above, and can be specified as the number of frames. In this embodiment, the number of non-detections is recorded, the same process is performed for the next video frame, and if a watermark code of a proper order is detected thereafter, the number of non-detections is initialized. If the number of non-detections that is not initialized in the middle and continuously increases corresponds to the specified delay time, the decision controller 245 outputs a warning signal.

On the other hand, when a detection notification of frame synchronization is received, the decision controller 245 reads the watermark code that should be included in the subsequent video frame from the watermark profile 221 and loads it into the register 242 according to the code sequence, and simultaneously resets the value of the counter 244.

In the above-mentioned embodiment, the watermark generator 10 repeatedly writes the same watermark code on each video line, and cyclically writes different watermark codes for each video frame, and transmits them to the receiver through the link 30. At the receiving end, the frozen decision unit 24 decides whether the video stream is frozen or not for the video stream in which the watermark is written and transmitted, however, the writing of the watermark for deciding whether or not the video is frozen can be performed according to various embodiments other than those described above. These embodiments will be described in detail below.

In another embodiment according to the present invention, one bit is recorded for each image line for the watermark code. That is, a unit section becomes one video line, and video lines corresponding to the number of bits of the watermark code become code blocks. FIG. 10 shows an example in which a watermark is written into a video frame according to an embodiment of the present invention. In the present embodiment, the write control signal (Rp_{ACT}) and the detection control signal (_{W}D_{ACT}) output by the write timing controller 122 and the detection timing controller 222 are activated only once for each video line, and the activation start time point is determined by the watermark policy information as described above.

In another embodiment according to the present invention, when one hidden bit is inserted into each video line, the insertion position can be dynamically changed as shown in FIG. 11. Further, the position to be dynamically changed can be determined in conjunction with the frame number included in the video stream. For example, when hidden bits are inserted while dynamically changing them at 2^{N} different positions, the position is determined by referring to the lower N bits of the frame number. When detecting a watermark at the receiving stage, the position of the hidden bit is also dynamically determined, and the bit corresponding to the watermark is read at the corresponding position.

Information about the frame number can be confirmed from the corresponding field included in the frame start packet 1101 where the frame synchronization is prefixed. Therefore, in this embodiment, the watermark inserter 13 and frozen video detector 20 are separately provided to include a means for extracting this frame number. This detection means extracts the frame number from the corresponding field of the frame start packet 1101 for each video frame, and provides it to the write timing controller 122 in the watermark inserter 13 and provide to the detection timing controller 222 in the frozen video detector 20, so that the activation start time of the write control signal (Rp_{ACT}) and the detection control signal (_{W}D_{ACT}) is adjusted according to the frame number.

If a complete watermark code is not inserted into each video line as in FIGS. 10 and 11, but a bit string of a watermark code is inserted sequentially across consecutive lines, and if even one video line in a video frame is defective due to an error such as channel distortion, not only the watermark code with hidden bits in the defective line, but also all of the same watermark codes inserted after the defective bits have their bit strings divided and changed, and there is a risk that they will not match the watermark code that should be detected in the corresponding frame.

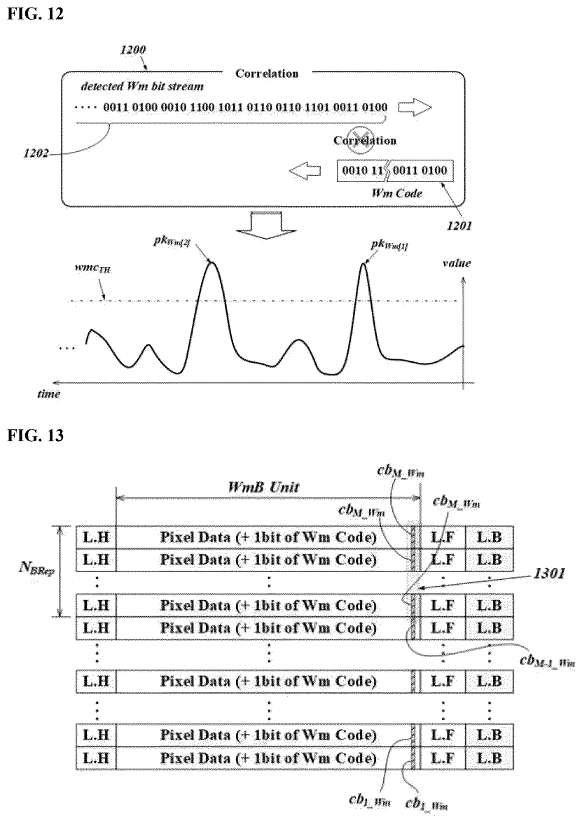

Therefore, in an embodiment according to the present invention, instead of a simple bit string comparison, a method is used that can reliably detect a watermark code even when some hidden bit strings are defective. FIG. 12 is a schematic diagram showing a method for detecting a watermark cord through correlation according to an embodiment of the present invention. For this purpose, the frozen decision unit 24 is configured to include a correlation detector that replaces the comparator 243 and the counter 244, and this correlation detector performs the detection method illustrated in FIG. 12.

The correlation detector loads hidden bit strings into the internal memory in the order in which they are filled each time they are filled in the shift register 241. Then, when a notification of frame synchronization detection is received, the correlation between the watermark code 1201 loaded into the register 242 to be detected in the current video frame and a series of hidden bit strings 1202 filled into the internal memory is calculated (1200).

When a section of a bit string that matches the watermark code 1201 exists by calculating the correlation in this way, a peak value (pk_{WM[i]}, i=1, 2, . . . ) greater than or equal to a pre-specified limit value (wm_{CTH}) is obtained. The correlation detector notifies the number of peak values obtained in this way to the frozen decision unit 24, and the frozen decision unit 24 compares the notified peak value with the standard detection number specified in the watermark policy information. If it is greater than or equal to the standard detection number, it decides that the watermark has been detected, and if not so, it decides that the watermark has not been detected.

If watermark detection is performed through correlation calculation in this way, a peak value is obtained from the bit string of the watermark code without bits defect even if there are some bit defects in a series of silver mark bit strings, and this is reflected in the watermark detection decision. Thus, if the reference detection number is set appropriately, watermark detection can be performed very stably unless a significant number of line defect occur in the image frame.

Yet another embodiment of the present invention is described to a considerable extent even when there are partial line defects. FIG. 13 is an example showing a method of writing a watermark code in a video frame according to the present embodiment. In the present embodiment, each hidden bit is sequentially recorded in video lines by a determined number (N_{BRep}) (1301). Of course, the duplicate number of times (N_{BRep}) is a value specified in the watermark policy information. Alternatively, the duplicate number of times may be determined dynamically and used according to the number of lines of the video frame. For example, when the bit length of the watermark code used is 32 bits, the duplicate number of times may be determined to be a maximum of 20 (=640/32) if the number of lines of the image is confirmed to be 640. The maximum duplicate number of times is the number of times when the watermark code can be written once by repeating each bit in one video frame by that number of times.

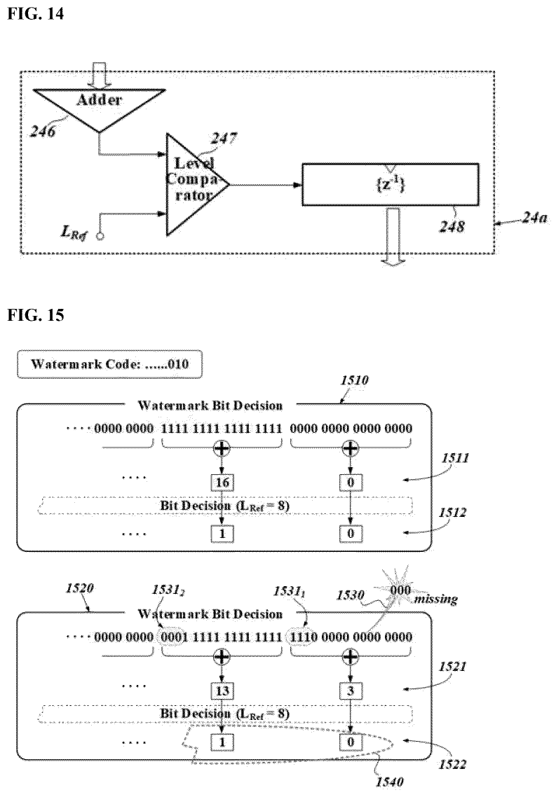

In an embodiment where hidden bits are inserted while continuously overlapping with a watermark code as illustrated in FIG. 13, the frozen decision unit 24 is configured to include a code detector 24a of FIG. 14, which replaces the comparator 243 and the counter 244. This code detector 24a is configured to include an adder 246, a level comparator 247, and a second sheet register 248. Whenever there is a bit decision start signal from decision control section 245, an operation to decide hidden bits is performed according to a method whose concept is schematically depicted in FIG. 15.

The bit decision start signal is applied each time bits corresponding to the number of hidden bit duplications mentioned above are detected by the mark bit detector 23 and filled in the shift register 241. When this signal is applied, the adder 246 loads the bit strings filled in the shift register 241 and aligned sequentially and outputs the added values 1511 and 1521. The level comparator 247 compares the output value of the adder 246 with a previously specified reference level (L_{Ref}), and outputs a value of 1 if it is greater than that, and 0 if it is not (1512, 1522). The reference level (L_{Ref}) used at this time is determined in conjunction with the number of duplications for the previously mentioned hidden bits. In other words, it is specified as a value corresponding to half of the number of duplications.

The bits decided and output by the level comparator 247 are sequentially applied to the second sheet register 248 at the rear stage and filled as a bit string corresponding to the watermark code. When the bit string filled in this way corresponds to the bit length of the watermark code, the decision controller 245 reads the bit string and compares it with the watermark code to be detected in the current video frame written in the register 242, thereby deciding whether the watermark has been detected.

In this way, if the method of inserting each of the hidden mark bits in a successive manner is applied, the watermark code can be detected normally as illustrated in FIG. 15, even if several lines are defective in the image frame. The example in FIG. 15 assumes an example of transmitting the hidden mark bits 16 times in duplicate, and illustrates comparison between a video frame received with no defective lines 1510 and a video frame with three defective lines 1530.

According to the defects of three lines, even if some bits that are not all the same and have different values as duplicated hidden bits are mixed in the bit string added by the adder 246 (153ᵢ, i=1, 2, . . . ), when the number of those bits is less than half of the number of duplicated bits, the level comparator 247 at the subsequent stage is not affected by the mixed bits but decides the correct hidden bit 1540. That is, the embodiment in which one bit is inserted into each video line so that the hidden bit is duplicated several times has tolerance for line defects that are less than half of the duplicate number of times.

In the embodiments of the present invention described so far, each bit is detected at positions where a watermark should be inserted in a received video frame, and the detected series of bit strings, i.e., target codes, are compared with watermark codes that should be inserted in the corresponding video frame according to rules agreed upon between both transmitting and receiving sides, and whether or not the image is frozen is decided based on whether or not they match. However, the technical idea and principle of the present invention are not limited to these embodiments but can be implemented. In these embodiments, the process of comparing the target code obtained from the video frame with the watermark code determined according to the agreed order is omitted. Instead, comparison with the target code obtained from the immediately preceding received image frame is used.

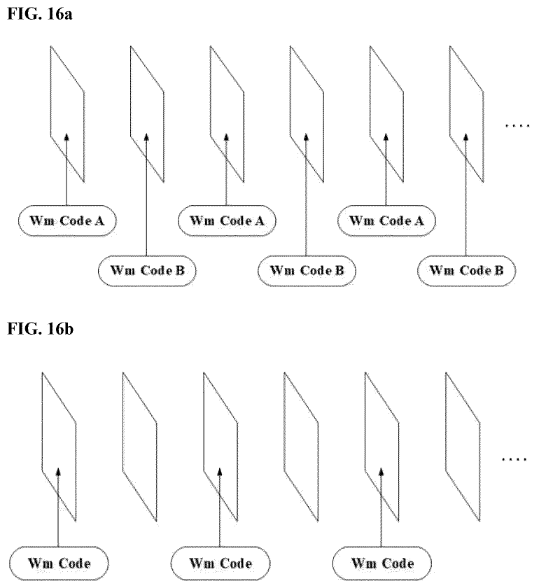

FIGS. 16a and 16b show examples of a method in which the watermark insertor 13 inserts a watermark code into each video frame according to the embodiments. FIG. 16a shows a scheme in which two watermark codes are inserted and transmitted to each video frame while alternating between each other, and FIG. 16b shows a scheme in which a single watermark code is inserted and transmitted to video frames while alternating between insertion and skipping. In the embodiment illustrated in FIG. 16a, more than two watermark codes may be used. In the embodiment of FIG. 16b, a plurality of different watermark codes may be used, and while these watermark codes are in use, a video frame is skipped at one time without writing a watermark code.

When a watermark code is inserted into a video frame in the manner illustrated in FIGS. 16a and 16b, the aforementioned embodiments of inserting the watermark code once or repeatedly into each video line may be combined, and the aforementioned embodiments of inserting only a single hidden bit into each video line may be combined.

Further, when the present invention is implemented according to the method illustrated in FIG. 16a, it is preferable that the watermark code inserted into the video frame be a pseudo-noise code having noise characteristics, but it is not necessarily limited thereto, and only a single bit may be used. That is, only one bit may be inserted transmitted per frame. In this case, the watermark code inserted alternately must naturally be 0 and 1.

In addition, when a watermark code is inserted in the manner illustrated in FIGS. 16a and 16b, the position in each video line where it is inserted may also be varied in conjunction with the frame number of the video frame, as described in the previous embodiment.

In the case of inserting and transmitting a watermark code according to the method illustrated in FIGS. 16a and 16b, the detection of the target code included in the video frame in the frozen video detector 20 on the receiving terminal side is performed in the same manner as in the previous embodiments. However, there is a difference in that the decision of whether the video is frozen based on the detected target code is performed only when there is a target code detected in the previous frame (in the case of the embodiment of FIG. 16b, in either of the previous or next frames).

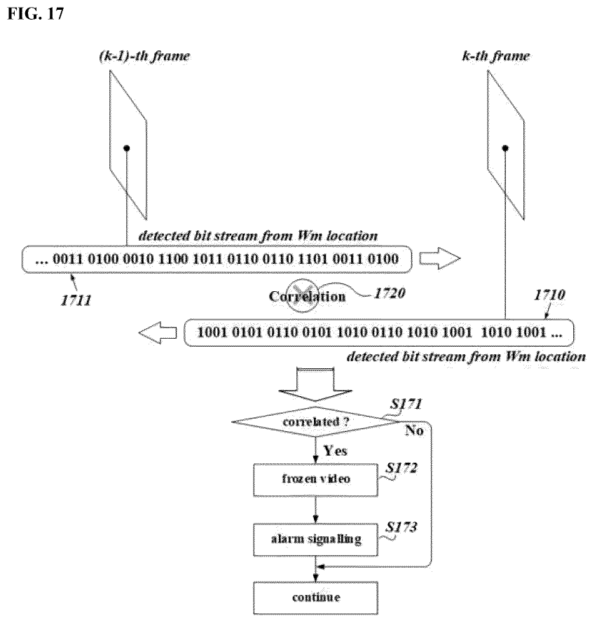

FIG. 17 is a schematic diagram showing a method of deciding whether a video is frozen in this embodiment, wherein the frozen decision unit 24 of the frozen video detector 20 is configured to include a before-after correlation calculator 1720 that calculates the correlation between the target code 1710 extracted from the current video frame and the target code 1711 extracted from the immediately preceding video frame when the target code 1710 is extracted from the current image frame. When the correlation between the two target codes 1710 and 1711 is calculated by the before-after correlation calculator, the decision controller 245 that receives the calculated value decides whether a video is frozen based on the correlation value.

That is, as described above in relation to correlation calculation, if it is confirmed that the correlation between the two target codes 1710 and 1711 shows a peak value equal to or greater than a predetermined limit value and thus the two target codes are correlated with each other (S171), the decision controller 245 decides that the same watermark code is inserted between the video frames connected to each other in the front and back, and decides that the current image is frozen (S172). If it is decided to be a frozen video, a warning signal is immediately (depending on the embodiment, when it is continuously decided to be a frozen video for a prescribed period of time) notified to a preset device (S173).

It is preferable to use a pseudo-noise code so that the watermark inserted repeatedly does not appear as a visual expression that attracts attention, but in an embodiment where the insertion position is changed for each video frame, it is acceptable to use an arbitrary bit string of a prescribed size, especially a short length, without using a pseudo-noise code.

Further, in an embodiment where watermark codes of different values determined by arbitrary bit strings are inserted alternately for each video frame, a method of directly comparing both bit strings can be used, rather than the method of calculating the correlation between previous and next frames as described above. Further, in such an embodiment, the watermark code inserted into each frame may consist of only 1 bit, that is, values of 0 and 1.

Unless the various embodiments, for the method for detecting whether a video signal is frozen according to the present invention and various embodiments of the device for the method, and the configuration and operation described in the embodiments, etc., specifically described so far are incompatible with each other, the explained embodiments can be properly chosen in various ways and then combined to embody the concept and idea of the present invention.

The above-mentioned embodiments of the present invention have been disclosed for illustrative purposes, and those skilled in the art will appreciate that various improvements, modifications, substitutions or additions can be made in the embodiments without departing from the technical spirit and scope of the present invention disclosed in the appended claims.

### DESCRIPTION OF REFERENCE NUMERALS

| | |
|---|---|
| 10: watermark generator | 11, 21: synchronous detector |
| 12: writing scheduler | 13: watermark inserter |
| 20: frozen video detector | 22: reading scheduler |
| 23: mark bit detector | 24: frozen decision unit |
| 24a: code detector | 30: link |
| 121, 221: watermark profile | 122: write timing controller |
| 131: first delay register | 132: second delay register |
| 133: bit replacer | 134: CRC reviser |
| 222: detection timing controller | 231: flip-flop |
| 232: gate | 241: shift register |
| 242: register | 243: comparator |
| 244: counter | 245: decision controller |
| 246: adder | 247: level comparator |
| 248: second shift register | |

What is claimed is:

1. A device for transmitting an input video stream to other devices through a communication channel, the device comprising:
a detector that detects the start of each video frame and the start of each video line within the video frame in the input video stream,
an inserter configured such that based on the start of each video frame and the start of each video line detected by the detector, in at least one of N (N is two or more) video frames that are temporally contiguous in a video stream, a specific mark consisting of 1 bit or more is inserted by replacing a part of the pixel data of the video stream, and the CRC data added to a video line with respect to a video line into which the bit of the replaced or inserted specific mark is replaced with CRC data that matches the video line including the replaced or inserted bit.

2. The device according to claim 1,
wherein the inserter is configured to insert the specific mark into each of the N video frames, and the specific mark inserted into each of the N video frames is composed of different codes.

3. The device according to claim 2,
wherein the inserter is configured to repeatedly insert the code of the specific mark multiple times for each video line of an arbitrary video frame.

4. The device according to claim 2,
wherein the inserter is configured to insert by every one bit with respect to the code of the specific mark.

5. The device according to claim 4,
wherein the inserter inserts a bit of the code of the specific mark in such a manner that one bit is duplicated across multiple consecutive video lines in an arbitrary video frame.

6. The device according to claim 2,
wherein the different codes are one or more bit strings.

7. The device according to claim 6,
wherein the different codes are composed of pseudo noise codes.

8. The device according to claim 7,
wherein the N is 4 or more, and bit values at the same position are not all equal between different codes from each other.

9. The device according to claim 1,
wherein the inserter is configured to skip one of the N video frames without inserting the specific mark.

10. The device according to claim 1,
wherein the inserter is configured to insert the specific mark into an arbitrary video frame by specifying a position different from the position where the specific mark was inserted in the video frame which is immediately preceding the arbitrary video frame.

11. The device according to claim 10,
wherein the inserter is configured to specify the different position in connection with the frame number written in a packet that packs the arbitrary video frame.

12. The device according to claim 1,
wherein the inserter is configured to replace or insert the bit of the specific mark in a video line of an arbitrary video frame, based on a bit length that is the least common multiple of the number of bits of a unit that completes information about one pixel and the number of bits in a byte.

13. The device according to claim 1,
wherein, when the respective each video lines are constituted in the form in which pixel data distinguished by brightness and color are continued, a video line portion in which a bit of the specific mark is replaced or inserted is a portion of the pixel data of the color.

14. The device according to claim 1,
wherein a video line portion in which the bit of the specific mark is replaced or inserted is the least significant bit of the pixel data.

15. A device for detecting frozen video in a video stream received through a communication channel, the device comprising:
a first detector that detects the start of each video frame and the start of each video line within the video frame in a received video stream,
a second detector configured to detect a bit at a target position specified for an arbitrary video frame of the video stream based on the start of each video frame and the start of each video line detected by the first detector, and
a decision unit configured to decide that the video stream is frozen if one or more target codes obtained from one or more bits individually detected by the second detector do not correspond to a specific code specified for the arbitrary video frame.

16. The device according to claim 15,
wherein the decision unit is configured to compare each of the one or more target codes with the specific code, and decides that the code does not correspond to the specific code if the matching number is less than a predetermined reference value.

17. The device according to claim 15,
wherein the decision unit is configured to calculate a correlation between the one or more target codes and the specific code of the continuous bit string, and decides that the code does not correspond to the specific code if a peak value equal to or greater than a certain limit value in the correlation is less than a predetermined reference value.

18. The device according to claim 15,
wherein the decision unit is configured to add a specified number as a unit to a bit string in which the bits detected from the second detector are consecutively aligned, and compare the result with a predetermined level, thereby obtaining one or more target codes through a method for deciding the specified number of bits as one bit of the target code.

19. The device according to claim 15,
wherein the decision unit is configured to specify the specific code by selecting from a set of a plurality of specific mark codes that are set in accordance with a previously agreed order with a transmitter that transmits a video stream through a communication channel.

20. The device according to claim 15,
wherein the decision unit is configured to specify the specific code by selecting from the plurality of specific mark codes that are set in accordance with an order specified by information set in the passively operable switch elements.

21. The device according to claim 15,
wherein the decision unit is configured to specify the specific code as a target code obtained from detection by the second detector in a video frame received immediately preceding the arbitrary video frame.

22. The device according to claim 15,
wherein the second detector is configured to detect a bit by specifying, as a target position, a position different from the position at which the bit is detected in a video frame which is immediately preceding the arbitrary video frame.

23. The device according to claim 22,
wherein the target position of the arbitrary video frame is specified based on a frame number written in a packet packing the arbitrary video frame.

24. The device according to claim 15,
wherein the decision unit is configured to continuously decide whether to freeze a subsequently received video stream for a preset period of time when the video stream is decided to be frozen, and
the decision unit is configured to output a signal notifying the freezing of the video stream when the decision to freeze the video stream is sustained for each video frame for the period of time.

25. A method for transmitting an input video stream to other devices through a communication channel, the method comprising:
a first step of detecting the start of an arbitrary video line within an arbitrary video frame in an input video stream,
a second step of replacing or inserting a bit of pixel data written at a position that is specified from the detected starting point of the arbitrary video line with 1 bit of a specific mark to be inserted into the arbitrary video frame, and
a third step of replacing CRC data added to a video line with respect an arbitrary video line in which at least one bit is replace or inserted, by CRC data that matches the video line containing the replaced or inserted bit.

26. A method for detecting frozen video in a video stream received through a communication channel, the method comprising:
a first step of detecting the start of an arbitrary video frame in a received video stream,
a second step of detecting the start of each video line in the arbitrary video frame whose start has been detected, and detecting a bit at a target position that is specified for the arbitrary video frame based on the detected start of each video line, and
a third step of obtaining one or more target codes from one or more bits individually detected in the second step, checking whether they correspond to a specific code specified for the arbitrary video frame, and determining that the video stream is frozen if they do not correspond to the specific code.
